(19) United States
(12) Patent Application Publication
(10) Pub. No.: US 2010/0042536 A1
(43) Pub. Date: Feb. 18, 2010

(54) System and method of transferring funds

(76) Inventors: Tim Thorson, Birmingham, AL (US); Harvey Sims, Hoover, AL (US); Stark Meissner, Prattville, AL (US)

Correspondence Address: STEPTOE & JOHNSON LLP, 1330 CONNECTICUT AVENUE, N.W., WASHINGTON, DC, 20036, US

(21) Appl. No.: 12/541,342

(22) Filed: Aug. 14, 2009

Related U.S. Application Data
(60) Provisional application No. 61/089,342, filed on Aug. 15, 2008.

(51) Int. Cl. G06Q 40/00

(52) U.S. Cl. 705/39

(57) ABSTRACT

A system for transferring funds can include a database with information about a routing number including ACH transfer information and wire transfer information. The system can include a conversion module configured to receive an ACH transfer file including an associated routing number, access the database to retrieve wire transfer information, and convert the ACH transfer file to a wire transfer file. The system can include an implementation module configured to perform a wire transfer using the wire transfer file. The wire transfer can be a batch wire transfer. The conversion module can use the associated routing number from the ACH transfer file to retrieve wire transfer information for the associated routing number from the database.

### CLAIM OF PRIORITY

This application claims priority to U.S. Provisional Application No. 61/089,342 filed Aug. 15, 2008, which is incorporated by reference in its entirety.

### TECHNICAL FIELD

The invention relates to a system and method of transferring funds from one payment mechanism to another.

### BACKGROUND

Automated Clearing House (ACH) is a system for electronically making payments into, and withdrawals from the accounts of businesses and individuals. The ACH system replaces the slower and more cumbersome paper-based system of checks and other forms of money transfers. The most common use of the ACH system is for direct deposit of payroll funds. Direct deposit is an electronic process that allows employers to make payroll funds available to their employees without having to write out a paper check. The funds are directly deposited into the employee's designated bank account one day forward. An alternate method of making payments is by wire transfer. Wire transfer is a same-day method of making payments.

Employers and financial institutions typically can use separate systems to handle ACH transfers and wire transfers. While batch ACH transfers are common, changing a transfer from an ACH transfer to a wire transfer is often difficult and must be done manually. Past methods and systems have not provided a process that allows a simple and automatic transition of payment from one method of transfer to another.

### SUMMARY

In general, a system for transferring funds can include a database with information about a routing number including ACH transfer information and wire transfer information. The system can include a conversion module configured to receive an ACH transfer file including an associated routing number, access the database to retrieve wire transfer information, and convert the ACH transfer file to a wire transfer file. The system can include an implementation module configured to perform a wire transfer using the wire transfer file. The wire transfer can be a batch wire transfer. The conversion module can use the associated routing number from the ACH transfer file to retrieve wire transfer information for the associated routing number from the database.

A method of transferring funds can include receiving an ACH file having information about an ACH transfer including an associated routing number. The method can include converting the ACH file to a wire transfer file using the information about an ACH transfer and information about wire transfers for the associated routing number as input. The method can include transferring funds using the wire transfer file. The wire transfer file can be a batch wire transfer file.

The details of one or more embodiments are set forth in the accompanying drawings and in the descriptions below. Other features, objects, and advantages will be apparent from the drawings, from the descriptions, and from the claims.

### DESCRIPTION OF DRAWINGS

FIG. 1 depicts a system of transferring funds.

FIG. 2 depicts a method of transferring funds.

### DETAILED DESCRIPTION

Employer payroll is usually managed by ACH transfer. The employer provides a financial institution, such as a bank, with a batch ACH file for its employees, including associated routing numbers. The bank will handle the batch ACH transfer, which is a one-day-forward process, i.e., the funds will be transferred overnight. When payday is a Friday, for example, then the ACH transfer is scheduled on Thursday and is completed on Friday. However, through employer or bank error, sometimes the ACH transfer is missed or sent late. Repeating the ACH transfer will effectively pay the employee late.

In order to pay an employee on time when an ACH transfer is missed or sent late, the financial institution can transfer the payroll funds using a wire transfer. It is common for wire instructions to be different from ACH instructions for a given bank, requiring the instructions to be looked up manually. Then, the individual wire instructions can be forwarded to the wire department where the individual wire transfers can be manually entered.

The systems and methods can be used to automatically transfer funds via wire transfer using scheduled Automated Clearing House (ACH) transfer information. A system for transferring funds can include a database with information about a routing number including ACH transfer information and wire transfer information. The system can include a conversion module configured to receive an ACH transfer file including an associated routing number, access the database to retrieve wire transfer information, and convert the ACH transfer file to a wire transfer file. The system can include an implementation module configured to perform a wire transfer using the wire transfer file. The wire transfer can be a batch wire transfer. The conversion module can use the associated routing number from the ACH transfer file to retrieve wire transfer information for the associated routing number from the database.

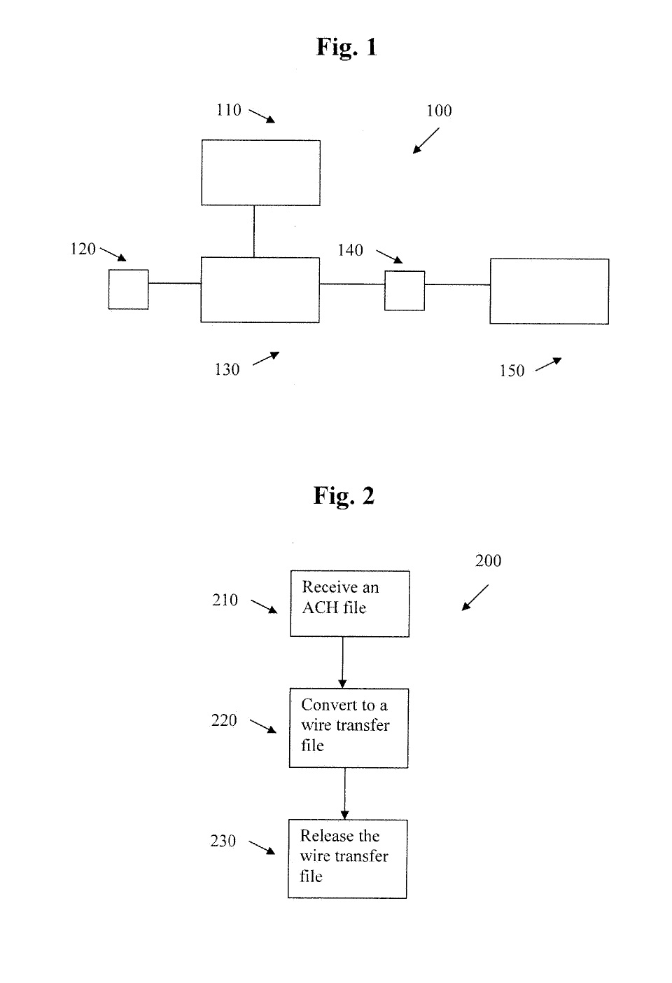

Referring to FIG. 1, in a system 100, a database 110 includes all data available for specific payment instructions, e.g., ACH and wire transfer, for each routing number. The database 110 can be a database provided and updated by Accuity, the Registrar of routing numbers for the American Bankers Association. The database 110 can be a database developed by the financial institution or by a vendor that includes routing number information and specific payment information for each routing number. An ACH transfer file 120 includes information about an ACH transfer, including a routing number. In certain circumstances, the ACH transfer file 120 can include two or more ACH transfer files with two or more associated routing numbers. A conversion module 130 receives the ACH transfer file 120 and uses the associated routing number or numbers to query the database 110. The conversion module 130 receives specific wire transfer information from the database 110 for the associated routing number or numbers and converts the ACH transfer file 110 to a wire transfer file 140. The wire transfer file 140 is then released as a batch wire transfer 150.

In an example that utilizes all modules shown in FIG. 1, an employer sends payroll information to a bank in a batch ACH transfer file that is a batch file that includes ACH transfer information for each ACH transfer for each employee, including associated routing number information for each ACH transfer. The batch ACH transfer is scheduled for payday and occurs automatically by the bank the day before payday. On payday, an error is discovered, by either the employer, employee, or bank, and the bank sends an ACH transfer file 120 for the incorrect ACH transfer or transfers. An incorrect ACH transfer can be a missed ACH transfer or an ACH transfer scheduled too late, for example. The ACH transfer file 120 includes the routing number information for the incorrect ACH transfer or transfers. The ACH transfer file 120 is sent to the conversion module 130 for conversion to a wire transfer file 140. The conversion module 130 receives the ACH transfer file 120 and, using the associated routing number, queries the database 110. From the database 110, the conversion module 130 receives specific wire transfer information for the routing number or numbers and creates the wire transfer file 140. The wire transfer file 140, which may be a batch file including several or many wire transfer instructions, is sent to a wire transfer department and then released.

The system 100 can be located in a financial institution such as a bank or may be located at an employer who will forward the wire transfer file 140 to its financial institution.

Referring to FIG. 2, a method 200 for the above-described system 100 is depicted. In step 210, the financial institution such as a bank receives an ACH file with information about an ACH transfer. The ACH file includes an associated routing number. Then, instep 220, the ACH file is converted to a wire transfer file, such as by using the conversion module 130 described above. The conversion module 130 uses the database 110 to retrieve specific wire transfer information for the associated routing number, and converts the ACH file to the wire transfer file. In step 230, the wire transfer file, which may be a batch wire transfer file with several or many wire instructions, is released.

The embodiments described above are offered by way of illustration and example. It should be understood that the examples provided above may be altered in certain respects and still remain within the scope of the claims.

It should be appreciated that, while the invention has been described with reference to the above preferred embodiments, other embodiments are within the scope of the claims.

What is claimed is:

1. A system for transferring funds comprising:
a database including information about a routing number including ACH transfer information and wire transfer information;
a conversion module configured to receive an ACH transfer file including an associated routing number, access the database to retrieve wire transfer information, and convert the ACH transfer file to a wire transfer file; and
an implementation module configured to perform a wire transfer using the wire transfer file.

2. The system of claim 1 wherein the wire transfer is a batch wire transfer.

3. The system of claim 2 wherein the implementation module automatically performs the wire transfer.

4. The system of claim 1 wherein the conversion module uses the associated routing number from the ACH transfer file to retrieve wire transfer information for the associated routing number from the database.

5. A method of transferring funds comprising:
receiving an ACH file having information about an ACH transfer including an associated routing number;
converting the ACH file to a wire transfer file using the information about an ACH transfer and information about wire transfers for the associated routing number as input; and
transferring funds using the wire transfer file.

6. The method of claim 5 wherein the wire transfer file is a batch wire transfer file.

7. The method of claim 5 wherein the transferring funds is automatic.
